(19) United States
(12) Patent Application Publication
(10) Pub. No.: US 2003/0041192 A1
(43) Pub. Date: Feb. 27, 2003

(54) CD-R burning device

(76) Inventors: Ming-Se Teng, Hsin Chu City (TW); Chee Kong Chong, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/935,837

(22) Filed: Aug. 24, 2001

(51) Int. Cl. G06F 13/12

(52) U.S. Cl. 710/62

(57) ABSTRACT

A CD-R burning deice includes a plurality of burning units connected with each other via an external interface. The burning unit further includes an operating unit, a source drive, a chipset, a hard disk and a plurality of burners. The source drive serves to read data stored in a parent disk of the source drive, and the chipset serves to execute the burning function according to the mode of the operating unit, read the data of the parent disk of the source drive through an internal interface, transmit commands or data through the external interface to the chipset of other burning units, or receive commands or data transmitted by the external interface. Meanwhile, the hard disk serves to store the data of the chipset through the internal interface, and burn the data to the disk inserted into the burner itself after being activated by the chipset.

### BACKGROUND OF THE INVENTION

(a) Field of the Invention

The present invention relates to a CD-R burning device, and more particularly to a CD-R burning device with a plurality of burning units connected to each other through interfaces electrically for a high-speed and large-volume data burning process.

(b) Description of the Prior Art

Conventional CD-R burning devices burners need to be incorporated with a computer operated with operating systems and have to be initiated by some specific application software. However, that kind of process could be time consuming and the capacity of disk burning is limited due to the necessity of cooperation of the computer. Therefore, an independent model has been developed without the cooperation of the computer. But if more disks are to be burned, even with this kind of model, the built-in control capability (such as speed and precision) needs to be improved for large-volume burnings, leading to enlargement of the cubic measurement of the model, which is quite inconvenient, and its expansion is quite limited.

Therefore, the inventor has come up with the present invention with reasonable design and effective improvement.

### SUMMARY OF THE INVENTION

To satisfy practical needs and solve the problems in existing technology, the present invention of CD-R burning device is developed to conduct a high-speed and large-volume data burning process.

The primary objective of the invention is to provide a CD-R burning device with burning units that is able to communicate all burning units simultaneously through high-speed interfaces like a wireless interface.

The second objective of the invention is to provide a CD-R burning device that stores data of a parent disk to its memory and then transmits them to many other burning units of the same type connected by interfaces.

The third objective of the invention is to provide a CD-R burning device that is capable of executing a high-speed and large-volume copy of data duplication.

The fourth objective of the invention is to provide a CD-R burning device burner that can be operated independently or in cooperation with other CD-R burning devices.

[Characteristics]

In accordance with the claimed invention, the burning unit comprises an operating unit, a source drive, a chipset, a hard disk and a plurality of CD-R burners. The source drive serves to read data stored in the disk inserted therein. The chipset serves to execute the burning function while operated under an input mode of the operating unit, meaning to read the data on the disk in the source drive through an internal interface and to transmit commands or data through the external interface to the chipset in other burning units, or receive commands or data transmitted from the external interface. The hard disk stores the contents of the chipset through an internal interface. The burners are respectively connected to the chipset through the internal interface, driven by the chipset to read the contents on the hard disk, and to burn the data to the disk within the burner.

### BRIEF DESCRIPTION OF DRAWINGS

FIG. 1 is a schematic diagram of the present invention.

FIG. 2 is a circuit block diagram of the present invention.

FIG. 2A is a circuit block diagram inside the chipset of the present invention.

FIG. 3 is a flow chart of the present invention.

### DETAILED DESCRIPTION OF PREFERRED EMBODIMENTS

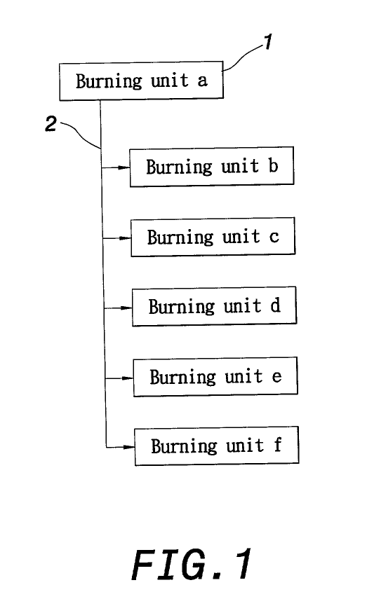

Please refer to FIG. 1, the present invention relates to a CD-R burner device (not shown), including a plurality of burning units 1, as burning units a, b, c, d, e, and f, which are connected via an external interface 2: The burning unit a serves the burning tasks for other burning units. This external interface 2 is a high-speed interface, such as an IEEE 1394 interface, a USB interface, an Ethernet interface, a fiber channel interface, or a wireless transmission interface.

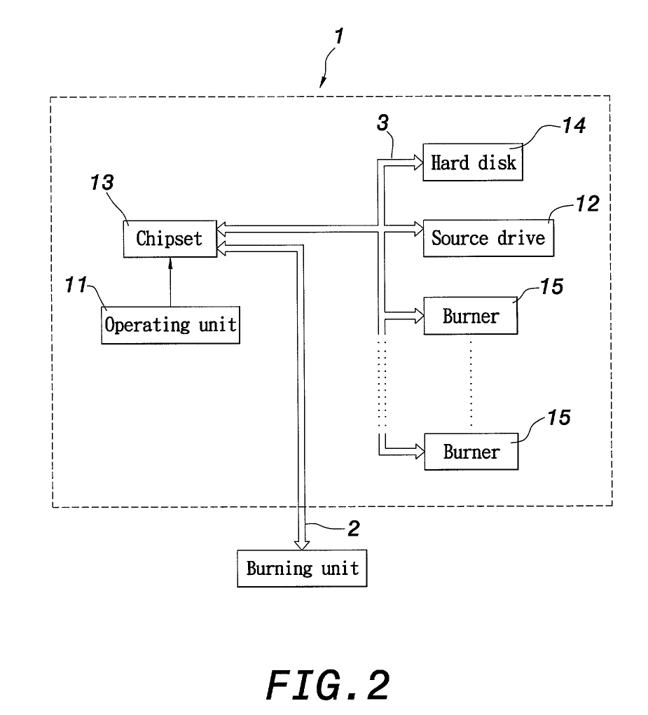

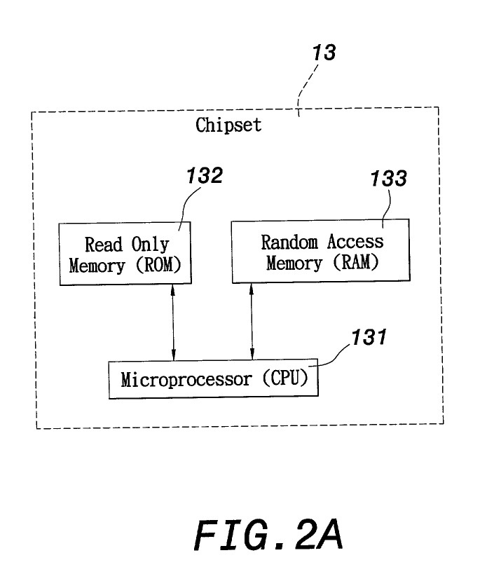

Please refer to FIG. 2 in conjunction with FIG. 2A, each burning unit 1 of FIG. 1 includes an operating unit 11, a source drive 12, a chipset 13, a hard disk 14 and a plurality of burners 15.

The operating unit 11 is designed with a burning function for executing a burning process.

The source drive 12 is used to read data from a parent disk (not shown), such as a CD-ROM or a DVD-ROM.

The chipset 13 consists of a microprocessor (CPU) 131, a Read Only Memory (ROM) 132, and a Random Access Memory (RAM) 133. The RAM 133 is optionally a Dynamic Random Access Memory (DRAM) or other kinds of memories.

The chipset 13 is connected with the operating unit 11 electrically, and serves to execute the burning of the operating unit 11. The internal interface 3 serves to read the data stored in the source drive 12, then store them in the RAM 133 of the chipset 13, transmit commands or data through the external interface 2 to other burning units, or receive commands or data from the external interface 2. The internal interface 3 is optionally a conventional IDE interface, a SCSI interface, or an IEEE 1394 interface, a USB interface or a wireless transmission medium.

The data of the RAM 133 of the chipset 13 through the internal interface 3 are written to and read from the hard disk 14. The burner, optionally a CD-R, a CD-RW, a DVD-R, or a DVD-RW, is respectively connected to the chipset 13 through the internal interface 3 and driven by the chipset 13 to read and burn the data of the hard disk 14 to the disk of the burner 15.

The burning unit 1 can be operated independently. When the parent disk is set forth in the source drive 12, the chipset 13 will transmit the data of this disk, according to the input mode of the operating unit 11, to the RAM 133 of the chipset 13, and store them in the hard disk 14. When the burner 15 is activated by the chipset 13, the burner 15 starts to copy the data of the parent disk to the disk of itself.

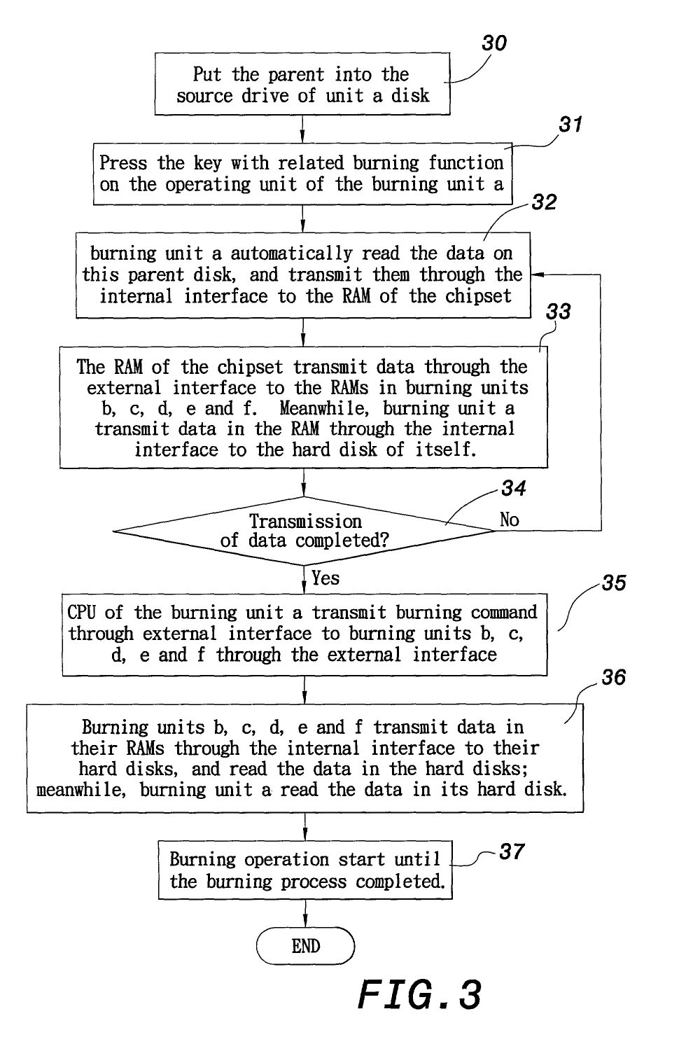

In addition to independent operation, the burning unit 1 can also be operated with other burning units through the external interface 2. Please refer to FIG. 3 of a control flowchart of the present invention. The present invention includes steps as follows:

Step 30: Put the parent disk in the source drive 12 of the burning unit a;

Step 31: Press the key with related burning function on the operating unit 11 of the burning unit a;

Step 32: The burning unit a automatically reads the data in the parent disk and transmits it through the internal interface 3 to the RAM 133 of the chipset 13;

Step 33: The RAM 133 of the burning unit a transmits data through the external interface 2 respectively to the corresponding RAMS 133 of the burning units b, c, d, e, and f; meanwhile, the burning unit a also transmits the data in the RAM 133 through the internal interface 3 to the hard disk 14;

Step 34: Is transmission of data completed?

If no, return to Step 32;

If yes, go to Step 35;

Step 35: The microprocessor 131 in the chipset 13 of the burning unit a transmits the burning commands through the external interface 2 to the burning units b, c, d, e, and f;

Step 36: The burning units (b), (c), (d), (e) and (f) transmit the data of the RAM 133 through their respective internal interface 3 to the hard disks 14 of themselves, and read the data from the hard disk 14; meanwhile, the burning unit a also reads the data in the hard disk 14;

Step 37: Starts burning process until it is completed.

This way, at the same time, many burning units can process the burning tasks simultaneously. If IEEE 1394 interface is adopted, 320 or more disks can be burned simultaneously.

Besides, the speed of the IEEE 1394 interface can be as high as 400 Mbps, or even up to 1.6 and 3.2 G bps or more. Thus when IEEE 1394 interface is adopted, the burning speed can be even higher.

[Characteristics of the Invention]

Therefore, the present invention of CD-R burning device has the following characteristics:

(1) No need of operating computer.

(2) Copying huge amount of data at higher speeds.

(3) To work independently or in cooperation with other burning devices.

(4) Easy expansion.

The present invention satisfies for a patent right, therefore, this application is filed in accordance with the patent law. Your favorable consideration will be appreciated.

It should be understood that the above description covering merely a preferred embodiment of the present invention accompanied with drawings shall not be based to restrict or limit the present invention, and that all equivalent modifications or variations made without departing from the above description shall be included in the intent and spirit of the appended claims.

What is claimed is:

1. A CD-R (Compact Disc Recordable) burning device with a plurality of burning units that are connected with each other by an external interface, each of the unit comprising:
an operating unit;
a source drive for reading data stored in a parent disk of the source drive;
a chipset for executing a burning process according to an input mode of the operating unit, and reading the data stored in the parent disk of the source drive through an internal interface, transmitting commands or data through the external interface to the chipsets in the other burning units, or receiving commands or data transmitted through the external interface;
a hard disk for storing the data of the chipset through the internal interface;
a plurality of burners respectively connected through the internal interface to the chipset and driven by the chipset to read and burn the data in the hard disk to the disks in the burners.

2. The CD-R burning device as claimed in claim 1, wherein the external interface is optionally an IEEE 1394 interface, a USB interface, an Ethernet interface, a fiber channel interface, or a wireless transmission medium.

3. The CD-R burning device as claimed in claim 1, wherein the operating unit has a press key for burning function.

4. The CD-R burning device as claimed in claim 1, wherein the source drive is optionally a CD-ROM or DVD-ROM.

5. The CD-R burning device as claimed in claim 1, wherein the chipset comprises a microprocessor CPU, a Read Only Memory (ROM) and a Random Access Memory (RAM).

6. The CD-R burning device as claimed in claim 5, wherein the RAM is optionally a Dynamic Random Access Memory (DRAM).

7. The CD-R burning device as claimed in claim 1, wherein the internal interface is optionally an IDE interface, a SCSI interface, an IEEE 1394 interface, a USB interface, an Ethernet interface, an optical channel interface or a wireless transmission medium.

8. The CD-R burning device as claimed in claim 1, wherein said burner is optionally a CD-R, a CD-RW, a DVD-R, or a DVD-RW.

9. A Compact Disc Redordable CD-R burning device comprising:
an operating unit;
a source drive for reading the data of a parent disk of the source drive;
a chipset for executing a burning process according to an input mode of said operating unit, reading the data stored in the parent disk of the source drive through an internal interface, transmitting commands or data through the external interface to the chipsets within other burning units, or receiving commands or data transmitted through the external interface;
a hard disk for storing the data of said chipset through the internal interface;
a plurality of burners respectively connected through the internal interface to the chipset and driven by the chipset to read and burn the data in the hard disk to the disks of the burners.

10. The CD-R burning device as claimed in claim 9, wherein the operating unit comprises a press key for burning function.

11. The CD-R burning device as claimed in claim 9, wherein said chipset comprises a microprocessor CPU, a Read Only Memory (ROM) and a Random Access Memory (RAM).

12. The CD-R burning device as claimed in claim 11, wherein said RAM is optionally a Dynamic Random Access Memory (DRAM).

13. The CD-R burning device as claimed in claim 9, wherein said internal interface is optionally an IDE interface, a SCSI interface, an IEEE 1394 interface, a USB interface, an Ethernet interface, an optical channel interface or a wireless transmission medium.

14. The CD-R burning device as claimed in claim 9, wherein said external interface is optionally an IEEE 1394 interface, a USB interface, an Ethernet interface, an optical channel interface or a wireless transmission medium.

15. The CD-R burning device as claimed in claim 9, wherein said burner is optionally a CD-R, a CD-RW, a DVD-R, or a DVD-RW.
